(19) United States
(12) Patent Application Publication
(10) Pub. No.: US 2006/0208913 A1
(43) Pub. Date: Sep. 21, 2006

(54) Remote product empty process alarm

(75) Inventors: Steven R. Christoffersen, San Antonio, TX (US); David E. Green, San Antonio, TX (US); Scott M. Thompson, San Antonio, TX (US)

Correspondence Address: LOEFFLER JONAS & TUGGEY, LLP, 755 EAST MULBERRY STREET, SUITE 200, SAN ANTONIO, TX, 78212, US

(73) Assignee: LOGICOR, L.L.C.

(21) Appl. No.: 11/311,114

(22) Filed: Dec. 19, 2005

Related U.S. Application Data
(60) Provisional application No. 60/638,026, filed on Dec. 18, 2004.

(51) Int. Cl. G08B 21/00; B67D 5/56

(52) U.S. Cl. 340/612; 222/129.1; 340/614

(57) ABSTRACT

The present invention, in a first embodiment, utilizes the vacuum generated in the empty syrup BIB container by the suction side of the syrup pump, located in the rear of the restaurant near store employees, to generate via a suitable transducer, a signal that will be transmitted to a suitable receiver located in the general proximity of a store clerk to make a notification of when a syrup BIB is drained of product. The signal emitted by the receiver will consist of a cue that is discernible to the attending employee(s), such as auditory, visual, or tactile.

This application is based upon and claims priority from U.S. Provisional application Ser. No. U.S. 60/638,026, which is incorporated herein by reference.

### BACKGROUND OF THE INVENTION

1. Field of the Invention

Applicants' invention generally relates to product empty process alarms, and particularly to remote product empty alarms for collapsible bladder reservoirs.

2. Background Information

Process fluids are sometimes supplied to the point of use packaged within a bladder, and typically, the bladder incorporates a check valve and fitting that interact with a purpose specified pump or metering device. The bladder of process fluid, which is finite in volume, coupled with a pump or metering device comprise a fluid delivery system that acts to supply the process fluid to a specific end point at the proper flow rate and/or pressure. In such situations, it is sometimes desirable for an alarm or other signaling means to be initiated that makes notification that the process fluid bladder is pending depletion and/or depleted and in need of replacement.

One exemplary setting is post-mix beverage dispensing. In the field of post-mix soft drink dispensing, carbonated water and concentrated syrup are supplied independently to the dispenser. Water is supplied through a carbonation tank to the dispenser. Syrup concentrate originates in a container, referred to in the industry as a “Bag-In-Box” (“BIB”). A BIB of syrup consists of a syrup filled plastic bladder packaged within a cardboard box. The bladder also contains a fitting and check valve that connects to an industry specified coupling with tubing that feeds the suction side of a demand, or syrup, pump. The pump is typically operated with pressurized gas and the pump is typically classified as a positive displacement pump.

The syrup concentrate is fed through the coupling and tubing into a positive displacement pump that ultimately pressurizes a syrup line between the pump and the post-mix dispenser, allowing syrup supply to the post-mix drink dispenser. The two components of the drink, carbonated water and syrup concentrate, are mixed, at a preferred ratio, through a valve at the point of dispense. Typically, post-mix dispensers are installed in restaurants, convenience stores, stadiums, amusement parks, cafeterias and other venues that cater to customer refreshment.

In recent years, there has been a general change in post-mix beverage dispensing from crew serve to self serve. Crew serve is when a store employee dispenses a drink. Self serve is when a customer dispenses a drink.

Periodically, the syrup concentrate BIB's become empty and it is necessary for a store employee to remove the empty BIB from the dispensing system and replace it with a full BIB. When a BIB becomes empty, a period of time can exist in which customers pay for drinks that do not have a sufficient amount of syrup, thus have an unacceptable taste. In some cases, such as when a customer chooses to dispense a lemon-lime drink where the syrup has no distinguishable color, the customer can not know that there is an absence of syrup. This issue is also present in a crew serve environment. Therefore, it is possible for a customer to receive a drink with insufficient syrup, become dissatisfied, and leave without notifying store personnel of the problem. This scenario allows the possibility for additional customers to become dissatisfied before store personnel are able to rectify the syrup out issue.

There are several devices commercially available that indicate a situation of sold out syrup. However, they are installed at the dispenser and include a pressure switch that senses loss of syrup pressure when the BIB is empty. The output of the pressure switch is electrically connected to a small light on the post-mix dispense valve that backlights a small “OUT” notation on the post-mix valve cover. The visual cue given by the light is typically dim and only marginally recognizable. Additionally, a sold out notification at the point of dispense in a self serve installation is of small value because self serve customers are not trained in post-mix dispense system service and maintenance and will likely not immediately understand the significance of the notification. The previously described implementation has proven only to be minimally acceptable for a crew serve application. In a self serve application it is unacceptable since store employees can not be proactively aware of a sold out situation.

It is desirable to derive a signal from near the BIB location in order to initiate operation of the remote product empty process alarm; however, it is also possible to derive a signal to operate the alarm from the dispenser location as well. Reasons why it is desirable to derive the signal in the BIB location include, but are not limited to:
The BIB is often located in a back room where the syrup supply originates and where the syrup pumps are located.
The back room is often a utility room in nature, and there is typically free space in which to install devices, whereas, the dispenser is typically installed in a commercial portion of a venue and there is sometimes limited, or no, space available to effect an installation of a device not originally included as original equipment on a manufactured dispensing unit.
Installation near the dispenser may conflict with the “look” of the venue, or contribute to undesirable “clutter” in the venue from the perspective of customers.
A typical transducer used to determine syrup out at the dispense location is a pressure switch that senses pressure in the syrup concentrate supply line. In some cases, syrup pumps can be supplied to a customer without a syrup pump shut off switch. In this case, even after a BIB has become empty, the syrup pump will still strive to pressurize the line between the pump and the dispenser, thus negating the effect of a pressure switch.

There are several reasons why this invention is novel and significant for the soft drink dispensing industry.
There has been a general shift over the past decade from crew serve to self serve (perhaps analogous to the trend a decade earlier in which gasoline stations migrated from full service attendants to self service pumping of gasoline). In self serve venues, the end user is dispensing a drink and that same end user is not specifically trained in the operation and maintenance of a post mix dispensing system. Notification of syrup out has been removed from the purview of the employee by an additional step. In this scenario, the remote product empty process alarm will provide a value payback to the venue owner in the form of satisfied customers and repeat business.
Discrete employees of a fast food restaurant and convenience store may not properly understand a post mix dispensing system and may erringly decide a service call is in order when a fountain head is not dispensing syrup rather than understand that the syrup supply has become depleted. In this scenario, the remote product empty process alarm will provide an economic payback to the venue owner in the form of eliminated service calls. In many cases an untrained employee does, in fact, initiate a service call with the result being that a trained service technician is dispatched to the store and simply changes the BIB at an increased cost to the store owner each time there is an occurrence of this sort.

### SUMMARY OF THE INVENTION

The contemplated embodiment of the present invention utilizes the vacuum generated in the empty syrup BIB container by the suction side of the syrup pump, located in the rear of the restaurant near store employees, to generate via a suitable transducer, a signal that will be transmitted to a suitable receiver located in the general proximity of a store clerk to make a notification of when a syrup BIB is drained of product. The signal emitted by the receiver will consist of a cue that is discernible to the attending employee(s). It is contemplated that various discernible cues could be used, so long as it is perceptible by one of the five senses, however an auditory, visual, or tactile cue is most likely to be used. It is also contemplated that the discernible cue could take the form of a combination auditory, visual, or tactile signals or alerts. For example, a buzzer might sound, a light turn on and the receiver begin to vibrate all as a part of the discernible cue to alert an employee of the product running low or out.

The store employees now have an opportunity to keep the post-mix dispensing system operational and mitigate the possibility of having a dissatisfied customer. The transducer and transmitter element described in this invention can be packaged as a stand alone unit which becomes an addition to the already present dispensing system. Also, through a minor modification to any of the available industry standard syrup pumps, a portion of the proposed system can be incorporated at a minimal cost penalty to the existing unit.

Although the contemplated embodiment described in this disclosure is related to post-mix dispensing of soft drinks, the device can logically be incorporated into any system in which a pump is supplying process fluid from a bladder reservoir. Other industries which use the similar bladder packaging method for process fluids include, but are not limited to, medical, chemical and foodservice condiments.

Accordingly, one embodiment of the present invention can be an indicator that includes four elements coupled together via conduit or other types of plumbing connections, mechanical connections, electrical connections, or wireless connections. The first element combines a positive displacement means integrally connected to a second element, an electrical contact switch, where the positive displacement element is acted upon by the presence and/or absence of a process fluid via a positive or negative pressure signal. The positive displacement device of the first element, integrally connected to the second element switch, shuttles the position of the switch between open contacts and closed contacts to supply a step change in input to a third element transmitter. The third element transmitter sends a signal to the fourth element receiver which is physically positioned within the venue in a area where an authorized person, such as a store employee, is available to receive a signal and react to it. The fourth element receiver is a device that is in communication with the third element and is able to transform the transmitted signal into a discernible cue, such as auditory, visual, or tactile. As the authorized person receives the auditory signal from the receiver, the realization then can occur that the syrup BIB is in need of refreshing. The use of an auditory signal is significant in that recognition of an audible signal, from a store employee's perspective, is omni-directional compared to a light source which requires the store employee to look in a certain direction and focus in on the fact that the indicator light is illuminated.

Additionally, it is an object of the present invention, to sense when a process fluid filled bladder reservoir is pending depletion and/or depleted and in need of replacement. Desirably, the method initiates an action, based on an input signal received from the suction side of a pump or metering device, to cause a signal to initiate an alarm or notification device.

It is a further object of the present invention to utilize the suction or low pressure created on the suction side of the syrup pump, when a BIB becomes depleted, for the purpose of operating a triggering device such as a mechanical contact switch interfaced with a suitable transmitter to send a transmitted signal via hard wired configuration to a suitable receiver that will convert the received transmitted signal into a discernible cue for use by an alarm device to ultimately indicate a product empty situation.

It is a further object of the present invention to utilize the suction created on the suction side of the syrup pump, when a BIB becomes depleted, for the purpose of operating a triggering device such as a mechanical contact switch interfaced with a suitable transmitter to send a transmitted signal via wireless configuration to a suitable receiver that will convert the received transmitted signal into a discernible cue for use by an alarm device to ultimately indicate a product empty situation.

It is a further object of the present invention to provide an automatic reset feature that allows the system to return to its original state after the system has been updated with a fresh supply of process fluid. The reset feature can be coupled with the positive displacement device of the first element and in the case of vacuum signal operation can include a mechanical return spring to ensure that the positive displacement device returns to its reset position.

It is a further object of the present invention to present an discernible alarm that is operated by the fourth element receiver after receiving a signal form the third element transmitter when a suction (vacuum) signal has caused the positive displacement device of the first element to move the integrally electrical contact switch of the second element and change the state of the electrical connection within the switch.

It is a further object of the present invention to provide a product empty indicator for syrup concentrate in a post-mix beverage dispensing system. Element one, element two and element three, as an assembly, may be installed in-line between the syrup Bag-In-Box (BIB) supply and the syrup pump.

It is a further object of the present invention to provide a product empty indicator for syrup concentrate in a post-mix beverage dispensing system. Element one, element two and element three, as an assembly, may be incorporated as an integral addition to a syrup pump already present in the venue. Specifically, the device can be incrementally designed into the gas shut off valve that is already present on most industry standard syrup pumps.

It is a further object of the present invention to provide a product empty indicator for syrup concentrate in a post-mix beverage dispensing system. Element one, element two and element three may be incorporated as an integral addition to a syrup pump accessory already present in the venue. Specifically, the device can be incrementally designed into the gas shut off valve accessory that is already available for many industry standard syrup pumps.

It is a further object of the present invention for the device to function as a product empty indicator that operates, getting its input signal from the input, or suction side, of a positive displacement pump.

It is a further object of the present invention for the device to function as a product empty indicator that operates, getting its input signal from the output, or pressure side, of a positive displacement pump.

It is a further object of the present invention to provide a timer that allows the alarm indication to function, programmably, for a discrete period of time.

The indicator of the present invention can be designed to be compact in shape, reliable in operation and durable in use. One particular feature of the present invention is that of an audible signal which is initiated with the pending depletion and/or actual depletion of a process fluid. An audible signal is preferable to a visual signal in that it can be heard and understood from an omnidirectional perspective. It is not necessary to be looking in a certain direction to “see” an indication of product depletion. Another particular feature is the fourth element receiver device. Inclusion of a timer circuit in the fourth element, which remains active while the electrical contacts of the second element remain in a steady state “on” position affords the benefit of a recurring discernible signal which will not stop cycling on and off until the store employee changes the BIB to a fresh one. Yet another particular feature of the present invention is an automatic reset which, through no human input, will place the device in a configuration ready for its next operation sequence. A still further feature of the present invention is its economical and readily adaptable ease with which it can be incorporated into the gas shut off valves presently available on industry standard post-mix syrup pumps.

### BRIEF DESCRIPTION OF THE DRAWINGS

FIG. 1. is an exploded perspective view of the monitor unit of the product empty process alarm.

FIG. 2. is a front view of the monitor unit of the product empty process alarm.

FIG. 3. is a side cut-away view of the monitor unit of the product empty process alarm.

FIG. 4. is a perspective view of the monitor unit of the product empty process alarm.

FIG. 5. is a perspective view of the receiver of the product empty process alarm.

FIG. 6. is a perspective cut-away view of the receiver of the product empty process alarm.

FIG. 7. is a schematic of the product empty process alarm.

### DETAILED DESCRIPTION OF THE PREFERRED EMBODIMENT

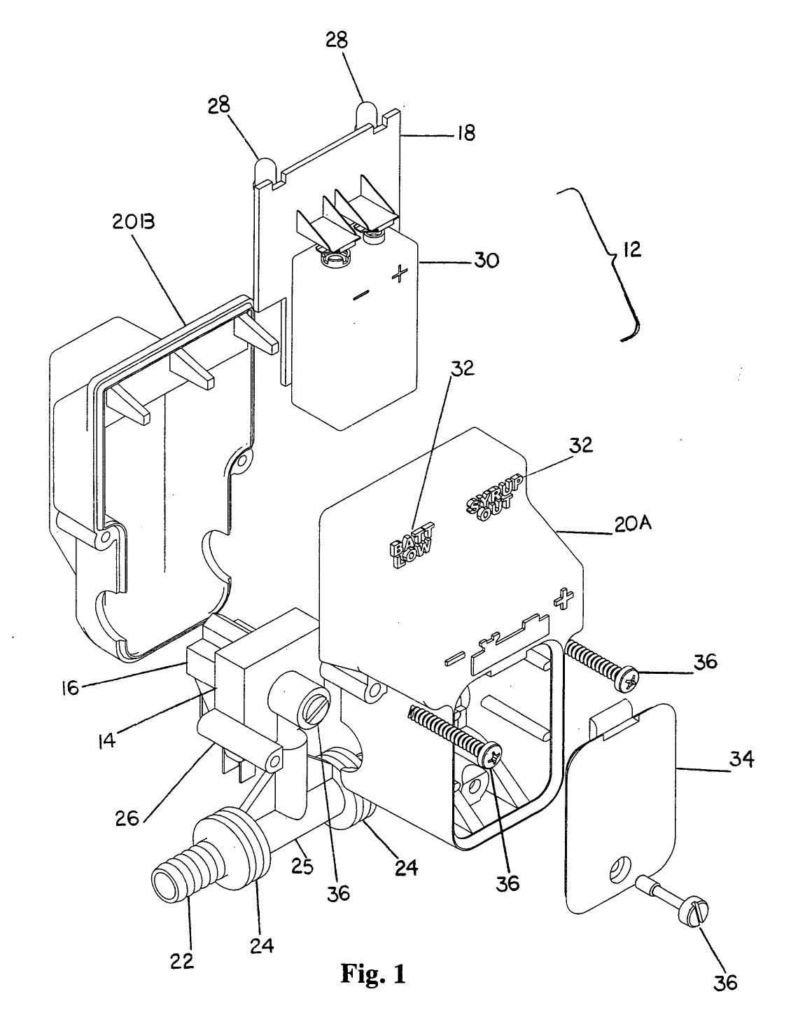

Referring to the figures, FIG. 1. illustrates one embodiment of a monitor unit (12) of the product empty process alarm (10). A first embodiment of element 1, the low product sensor (14), is essentially a low pressure sensor or a mechanical device that uses a vacuum switch (26) and moves as a result of a pressure change due to positive displacement. In the case of a BIB being the product source (2) using a syrup pump (not shown), the low product sensor (14), being a positive displacement unit in this embodiment, will be in communication with the product source (2) by being placed in-line with the product line (48A & B), and will typically use a diaphragm (not shown) as a positive displacement element (not shown) inside a diaphragm housing (25). The diaphragm housing (25) is connected to the product source (2) through the input side (suction side) of the positive displacement syrup pump or product source (2). When the product, which is liquid, runs low or out so as to cause a lowered pressure or vacuum, then the low product sensor (14) or positive displacement element (not shown) moves from its “home” or first position to an “activated” or second position sending a signal to the transmitter (18). This would occur when the syrup BIB or product source (2) is empty or almost so. There is typically a return spring (not shown) included within the housing (25) as well that serves to ensure that the positive displacement element (not shown) returns to its first state when the syrup BIB or product source (2) is not empty. While the low product sensor (14) is in a first state, no signal is sent. During the time the low product sensor (14) is in a second state, a signal is sent.

The monitor unit (12) receives power from a power source (30) that may be a battery, a connection to an outside power supply (not shown), hydraulic, or other appropriate energy supply. In order to protect the elements of the monitor unit (12), they may be contained in a housing (20) that may have multiple pieces such as first (20A) and second (20B) pieces that are attached using one or more connectors (36). The housing (20) may also provide for access to the elements via a access panel (34) that is removable via a connector (36).

The low product sensor (14) using a positive displacement device can also conceivably be placed on the output side (pressure side) of the pump (not shown) with an inverted mode of operation. In normal mode, when the BIB (2) is not empty, there will always be pressure in the product line (48A & B) leading from the product source (2) to the product dispenser (4). The setup for post-mix dispensing is that of a demand pump. The system is always pressurized and when a dispensing valve is opened, the syrup pump turns on to keep line (48a & b) pressure at a predetermined level. When the syrup BIB or product source (2) becomes depleted, the syrup line (48a & b) between the pump and product dispenser (4) experiences reduced pressure, hence, the low product sensor's (14) positive displacement device will undergo a change from its home state to its activated state and generate a signal for communication to the transmitter (18).

The low product sensor (14) can consist of devices other than a positive displacement device. The function of the low product sensor (14) is to produce a signal when the product source (2) becomes depleted. Therefore, the low product sensor (14) can conceivably be a weight scale (not shown) that monitors weight of the product source (2). When the weight registered by the scale drops below a predetermined weight, the low product sensor (14) or scale (not shown) moves from its first state to a second state, sending a signal to the transmitter (18).

It would also be possible to utilize an optic sensor as a low product sensor (14) to generate the signal. Syrup concentrate contained within a optically transparent tube (not shown) will exhibit different refraction and/or reflection properties as compared to the same tube (not shown) with no fluid contained within. This is typically the case when the BIB evacuates. Once no, or low, product is detected, the low product sensor (14) would act as described above to send a signal to the transmitter (18).

Additionally, it is also possible to detect presence of fluid by monitoring conductivity present within a supply tube using an electronic sensor. In this case, a system would be set up in which two electrical probes are situated within a conduit through which the process fluid (e.g., syrup concentrate) flows. Utilizing a suitable electronic means, conductivity between the two probes is monitored such that the electronics are able to differentiate between when fluid is present (one conductivity level) and when fluid is not present (a different conductivity level).

The product empty process alarm (10) may also include an element 2, or signal transformer (16), in communication with and between the low product sensor (14) and element three, the transmitter (18). The basic function of the signal transformer (16) is to transform the signal sent from the low product sensor (14) into a form that can trigger operation of the transmitter (18).

In one form, the signal transformer (16) can be a set of electrical switch contacts that are characterized as being in one state while the low product sensor (14) of element one is in its home position, such as in the case of positive displacement device being used for the low product sensor (14), the diaphragm would be “normally open” (first or home state) and closed (second or activated state) when the low product sensor (14) has detected a depletion of product (syrup). This change of state for the contacts, which is made possible because of the mechanical connection between the switch actuator of the signal transformer (16) and the positive displacement device of the low product sensor (14) creates a signal input for the transmitter (18) of element three to begin transmitting a signal to the receiver (38) of element four.

Utilizing the signal transformer (16) of the above description allows the transmitter (18) to operate in one discrete state at a time. Thus, there are a total of two possible states and for the transmitter (18), it represents off and on.

This type of operation is characterized as a discrete step input. The warning system of the product empty process alarm (10) remains dormant while the product source (2) has product (e.g. syrup bag has syrup), and then at some point when the product is exhausted, the discernable cue is actuated.

As described above, some embodiments of the low product sensor (14), such as a scale that weighs the product source (e.g. BIB), could provide a warning for pending depletion of product (e.g. syrup).

In another embodiment, the signal transformer (16) can be a variable resistance device (e.g., a rheostat) in which the input operator of the signal transformer (16) is physically connected to the positive displacement device of the low product sensor (14). As stated previously, if the embodiment of the low product sensor (14) uses a positive displacement device, it provides a linear displacement output that is related to the level of vacuum present in the supply side of the pumping device.

In this case, displacement of element one can provide a warning of pending depletion of syrup by virtue of the fact that as the BIB tends toward empty, there exists a discrete portion of dispense time during which there still is syrup in the BIB. Vacuum level in the supply side of the pump is increasing, but not yet at maximum.

Utilizing a variable output, the described product empty process alarm (10) can monitor the status of syrup supply and supply a pending syrup out notification to the store clerk because of the fact that a rheostat type device has an inherent graduated output feature.

As described relative to the low product sensor (14), in the case that the syrup bag is weighed, the weight input, supplied directly to a logic device can also supply a graduated input to the transmitter (18) that will allow for a notification of pending depletion as well.

The basic function of element three, the transmitter (18), is to receive an input signal from either element two, the signal transformer (16), or element one, the low product sensor (14), which is used as a trigger initiation of a transmitted signal which is ultimately received by element four, the receiver (38).

In one embodiment, the transmitter (18) can accept as input a dry contact switch and monitors whether the switch contacts are open or closed. A change of state of the switch contacts causes the transmitter to send the transmitted signal. The transmitted signal may be through a variety of ways, including without limitation, as wired or wireless such as via RF transmission. Alternately, it is possible to produce a logic circuit capable of accepting an input signal that triggers the transmitter (18) to transmit a wireless transmitted signal.

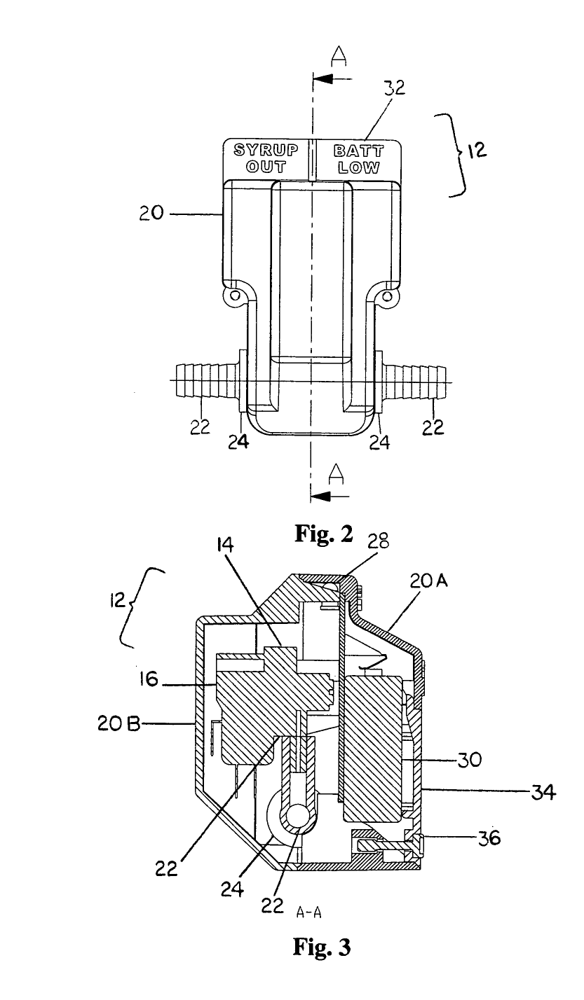

FIG. 2. is a front view of the monitor unit of the product empty process alarm. An embodiment of the monitor unit (12) incorporating a positive displacement unit inside the housing (20) is in communication with the product source (2) by being placed in-line with the product line (48A & B) using line fittings (22) which are sized to removably engage the product lines (48A & B). The O-rings (24) provides improved engagement due to liquid resistance and reducing leakage of the product. Also illustrated are the housing message indicators (32) which may be incorporated at the monitor unit (12) near the product source (2) and are illuminated by the lights (28).

FIG. 3. is a side cut-away view of the monitor unit of the product empty process alarm along axis A-A from FIG. 2. FIG. 3 illustrates a possible orientation of the various components of the monitor unit (12) in a first embodiment. Flow through the product line (48A & B) enters the monitor unit (12) through the line fitting (22). The O-ring (24) is located against the proximal end of the line fitting (22), and the diameter of the O-ring (24) is larger than the diameter of the line fitting (22) in order to provide an abutment against which the product line (48A or B) can be positioned. The housing first piece (20A) and second piece (20B) are positioned together and held by connectors (36). It is anticipated that housing pieces (20) may be held together by a number of different fasteners including, without limitation, mechanical “pin”-type fasteners such as screws, bolts, or rivets, adhesives, welds, soldering, clamps, and the like. Additionally, it may be advantageous to make the seams between the housing pieces (20) moisture proof or resistant, because of the environment in which the monitor unit (12) is often placed. This figure also illustrates how access to the power source (30) can be made through the access panel (34).

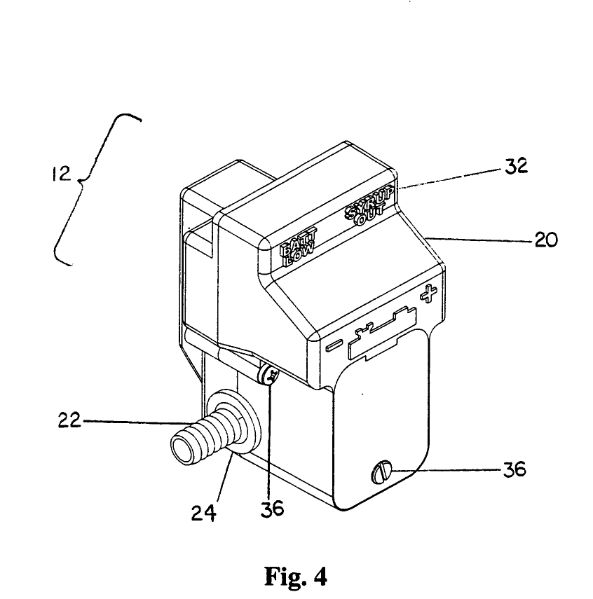

FIG. 4. is a perspective view of the monitor unit of the product empty process alarm. This figure provides an overall view of the monitor unit (12). It illustrates how compact the monitor unit (12) can be, making in-line placement relatively simple. It is advantageous for the monitor unit (12) to be self-contained. The monitor unit (12) can be installed post-product line (48) installation by simply cutting the product line (48) in order to create product line input (48A) and a product line output (48B), then attaching the ends of the product lines (48A & B) to the line fittings (22). The monitor unit (12) can be suspended, held be just the product lines (48A & B) to the line fittings (22) connections, or it may be attached to a substrate (not shown).

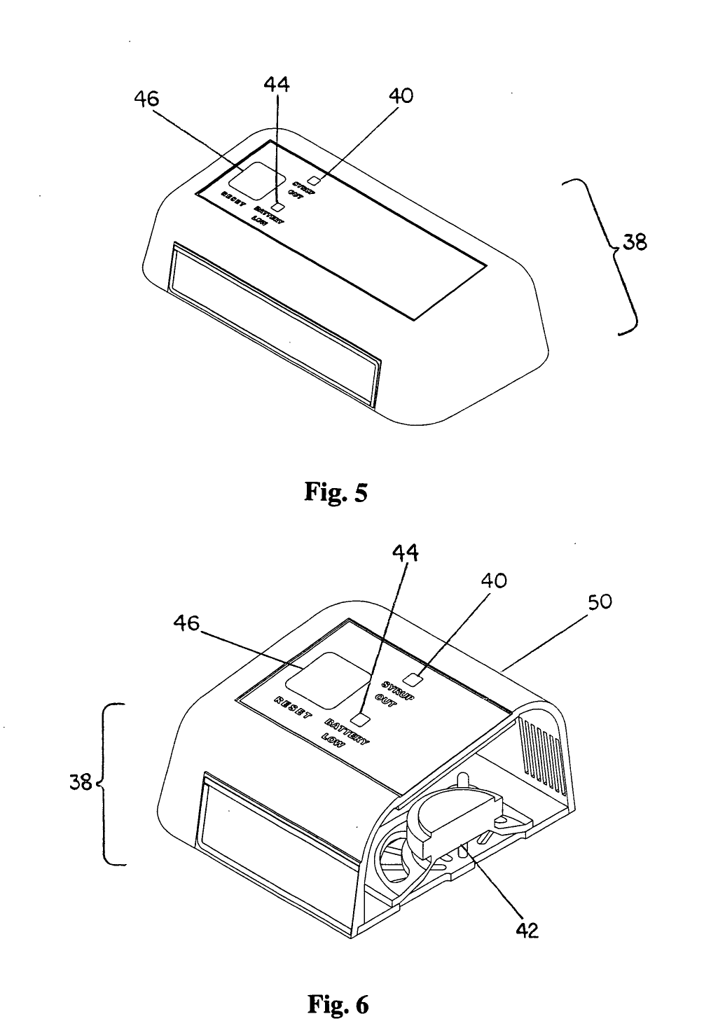

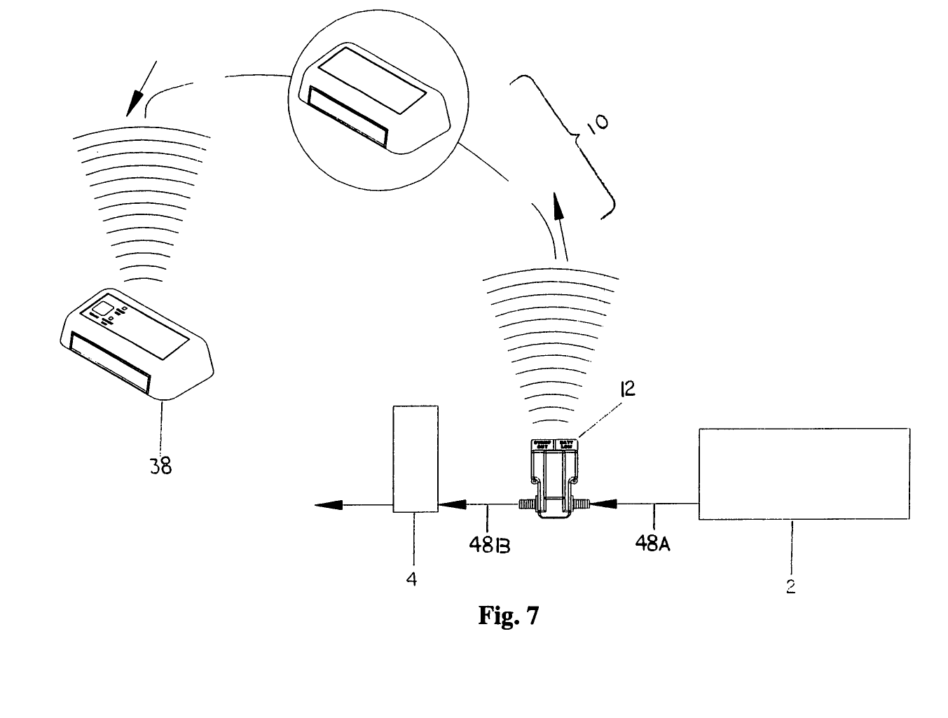

FIG. 5. is a perspective view of the receiver (38) of the product empty process alarm (10). The primary function of the receiver (38) is to provide a discernible cue or cues to the employee. The discernible cues may incorporate alarms to any of a person's senses, but will generally be sound, sight, and tactile. It is anticipated to be a self-contained unit that may placed in a variety of locations accessible to the attendants. In a retail store setting, the receiver (38) is preferably physically located near the cash register or other station within the venue where an employee will typically be present. The receiver (38) may also be worn on an attendant's person, which is generally required if a tactile discernible cue, such as vibrating, is employed.

FIG. 6. is a perspective cut-away view of the receiver (38) of the product empty process alarm (10). The basic function of element four, the receiver (38), is to receive the transmitted signal from the transmitter (18) and as a result of that transmitted signal, initiate a discernible cue, such as an audible, visual, or tactile signal, to the store employee(s) on duty at that time. In this figure, the interior of an embodiment of a receiver (38) is shown, illustrating the auditory cue (42), in this embodiment a speaker. The other illustrated cue is the visual cue (40), illustrated here as light. Either of the cues may turn on to alert the employee. Other functions may be incorporated, including without limitation, such as a reset mechanism (46) to stop the alarms or a message indicator (44) to alert the user that the power source (30) is depleted.

In one embodiment, the receiver (38) can accept as input the transmitted signal from the transmitter (18) and as a result changes the state of a pair of output electrical contacts (not shown). A alarm device, such as an visual cue (40) or an auditory cue (42) can be connected to the output contacts of element four and initiate a discernible cue when the state of the contacts indicates a low or out of product state of the product source (2).

Alternately, it is possible to produce a logic circuit capable of accepting a wireless transmitted signal that triggers the receiver (38) to produce the auditory cue (42).

It is anticipated that alternate embodiments fulfilling the same functions as described above could be employed to the same effect. Most of the above discussion is related to an alarm system that begins with movement of a positive displacement element that is coupled to a step change input device (i.e., a switch). However, it is also possible for the first element to combine a positive displacement means with an integrally connected spool portion of a spool valve. As the positive displacement device senses a change in pressure, its movement integrally changes the position of the connected spool valve. This change in spool valve position can be utilized to divert flow path of the CO₂ supplied to operate the demand pump to a new use such as:

Divert the CO₂ to flow over a paddle wheel that spins through an Infrared (IR) emitter and collector array to generate a pulsed signal when the bag runs dry. This pulsed signal is essentially a digital signal that can be utilized by a proprietary electronics device to understand when syrup depletion has occurred.

It is possible for the electronics logic to simply see a frequency generated by this device and conclude that the syrup is depleted, hence there is no graduated signal, the system is either “full” of syrup or “empty” of syrup.

It is also possible in this configuration, for the electronics to see a graduated signal emanating from the paddle wheel generator. Since the CO₂ source for the paddle wheel generating signal is originally tied into the positive displacement device, gradually opening spool valve which is related to level of vacuum (or pressure) on the positive displacement device can be used to interpret how much syrup is left in the bag based on frequency of the generated signal.

In the case of almost depleted, but not quite depleted syrup, the frequency of the pulsed signal would tend to be slightly lower than when syrup is completely depleted.

As is the case for the positive displacement device, the level of vacuum present determines the extent of displacement registered with element one. As syrup starts to deplete, level of vacuum in the pump supply line begins to increase, but does not reach the level present when the bag is completed depleted.

In a second alternative embodiment, similar to the first alternative embodiment, the configuration is again related to an alarm system that begins with movement of a positive displacement element that is coupled to a step change input device (i.e., a switch). Again, first element positive displacement means is combined with an integrally connected spool portion of a spool valve. As the positive displacement device senses a change in pressure, its movement integrally changes the position of the connected spool valve. This change in spool valve position can be utilized to divert flow path of the CO₂ supplied to operate the demand pump to a new use such as:

Divert the CO₂ to flow over a paddle wheel that spins a small DC electrical generator to generate a graduated voltage signal that is based on rotation rate of the paddle wheel. This graduated voltage signal is then utilized by a proprietary electronics device to understand when syrup depletion has occurred.

It is possible for the electronics logic to simply see a voltage generated by this device and conclude that the syrup is depleted, hence there is no graduated signal, the system is either “full” of syrup or “empty” of syrup.

It is also possible in this configuration, for the electronics to see a graduated signal emanating from the paddle wheel generator. Since the CO₂ source for the paddle wheel generating signal is originally tied into the positive displacement device, gradually opening spool valve, which is related to level of vacuum (or pressure) on the positive displacement device can be used to interpret how much syrup is left in the bag based on voltage level of the generated signal.

In the case of almost depleted, but not quite depleted syrup, the voltage level of the produced signal would tend to be slightly lower than when syrup is completely depleted.

As is the case for the positive displacement device, the level of vacuum present determines the extent of displacement registered with element one. As syrup starts to deplete, level of vacuum in the pump supply line begins to increase, but does not reach the level present when the bag is completed depleted. Therefore, a relatively low voltage signal can be interpreted by the electronics as if the syrup is almost out and a relatively high voltage signal as if the syrup is completely depleted.

In the discussions above, it is anticipated that the transmitted signal may be by a wireless method such as radio frequency transmission, satellite transmission, or optic transmission. A third anticipated alternative embodiment is a complete departure from the preceding discussions. In this configuration, as opposed to using RF transmission through air, the transmission method is sound waves through a liquid fluid medium. This configuration consists of the following:

Element one is a positive displacement device that monitors pressure level in the pump supply line. Analogous to the above discussions, element one is connected to element two switch. Element two switch is connected to element three transmitter. However, in this case element three transmitter is a device that has a sonar or other type of immersed emitter in contact with syrup on the output side of the pump. Since the post mix dispensing system is set up with a demand pump, there is a straight through plumbing run from pump output to the post mix dispensing valve installed in the dispenser.

Element three can then emit a sound wave that can travel through the fluid (syrup) to a complimentary immersed pickup device, or microphone, installed in the syrup chamber of the post mix dispense valve installed in the dispenser. In the valve location, there is typically room within the enclosure to include a circuit board and speaker, acting as element four, which can transform the received signal into an auditory cue.

This embodiment may be less desirable in that the location from which the auditory signal originates is in the area of the customer and not the clerk, however, since the notification means is auditory and the location of element four is within the valve enclosure, it remains possible to tailor the auditory message to include spoken words that informs the customer of the syrup out problem. This type of notification to a customer, since in spoken words, can then be of practical use to a store owner. The auditory signal can be an instruction for the customer to inform the store clerk that the syrup supply is depleted.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A product empty process alarm for use for use with a product source that sends a liquid product through a product line, said product empty process alarm comprising:
a low product sensor in communication with said product source, wherein when low product is detected, said low product sensor causes a signal to be generated;
a transmitter in communication with said low product sensor to accept said signal, said signal causing said transmitter to send a transmitted signal; and
a receiver capable of receiving said transmitted signal, and said receiver generating a discernible cue upon receiving said transmitted signal.

2. The apparatus of claim 1, wherein said low product sensor comprises a low pressure sensor wherein said low pressure sensor is able to detect low pressure or a vacuum in said product source or in said product line, and wherein a detected reduced pressure causes said generation of said signal.

3. The apparatus of claim 2, wherein said low pressure sensor further comprises:
a diaphragm for measuring displacement;
a diaphragm housing, said diaphragm inside of said diaphragm housing, said diaphragm housing connected to said product line;
wherein when said pressure is sufficiently high, said diaphragm stays in a home position and when said product runs low or out so as to cause a lowered pressure or vacuum, said diaphragm moves to an activated position causing said generation of said signal.

4. The apparatus of claim 3, further comprising a return spring, wherein said return spring acts to return said diaphragm from said activated position to said home position when said product is not low nor out, ceasing said generation of said signal.

5. The apparatus of claim 1, wherein said low product sensor comprises a scale wherein said scale is able to detect the weight of said product in said product source, and wherein said detected weight being less than a predetermined weight causes said generation of said signal.

6. The apparatus of claim 1, wherein said low product sensor comprises an optic sensor wherein said optic sensor is able to detect the presence or absence of said product in said product line using refraction and/or reflection properties, and wherein a detection of absence of product in said product line causes said generation of said signal.

7. The apparatus of claim 1, wherein said low product sensor comprises an electronic sensor wherein said electronic sensor is able to detect the presence or absence of product in said product source or in said product line using changes in conductivity, and wherein a detected change in conductivity causes said generation of said signal.

8. The apparatus of claim 1, further comprising a signal transformer in communication between said low product senor and said transmitter, wherein said signal transformer alters aid signal generated by said low product sensor into a form that can trigger operation of the transmitter.

9. The apparatus of claim 1, wherein said discernible cue consists of one or more of an auditory cue, a visual cue, or a tactile cue.

10. The apparatus of claim 1, further comprising a housing, wherein said low product sensor and said transmitter are contained within said housing, and said housing is moisture proof.

11. The apparatus of claim 1, wherein said transmitted signal transmitted wirelessly.

12. The apparatus of claim 11, wherein said low product sensor comprises a low pressure sensor wherein said low pressure sensor is able to detect low pressure or a vacuum in said product source or in said product line, and wherein a detected reduced pressure causes said generation of said signal.

13. The apparatus of claim 12, wherein said low pressure sensor further comprises:
a diaphragm for measuring displacement;
a diaphragm housing, said diaphragm inside of said diaphragm housing, said diaphragm housing connected to said product line;
wherein when said pressure is sufficiently high, said diaphragm stays in a home position and when said product runs low or out so as to cause a lowered pressure or vacuum, said diaphragm moves to an activated position causing said generation of said signal.

14. The apparatus of claim 13, further comprising a return spring, wherein said return spring acts to return said diaphragm from said activated position to said home position when said product is not low nor out, ceasing said generation of said signal.

15. The apparatus of claim 11, wherein said low product sensor comprises a scale wherein said scale is able to detect the weight of said product in said product source, and wherein said detected weight being less than a predetermined weight causes said generation of said signal.

16. The apparatus of claim 11, wherein said low product sensor comprises an optic sensor wherein said optic sensor is able to detect the presence or absence of said product in said product line using refraction and/or reflection properties, and wherein a detection of absence of product in said product line causes said generation of said signal.

17. The apparatus of claim 11, wherein said low product sensor comprises an electronic sensor wherein said electronic sensor is able to detect the presence or absence of product in said product source or in said product line using changes in conductivity, and wherein a detected change in conductivity causes said generation of said signal.

18. The apparatus of claim 11, further comprising a signal transformer in communication between said low product senor and said transmitter, wherein said signal transformer alters aid signal generated by said low product sensor into a form that can trigger operation of the transmitter.

19. The apparatus of claim 11, wherein said discernible cue consists of one or more of an auditory cue, a visual cue, or a tactile cue.

20. The apparatus of claim 11, further comprising a housing, wherein said low product sensor and said transmitter are contained within said housing, and said housing is moisture proof.

21. The apparatus of claim 11, wherein said wireless transmission of said transmitted signal is by one of: radio frequency transmission, satellite transmission, optic transmission, or by sound waves through a liquid medium.

22. A product empty process alarm for use for use with a product source that sends a liquid product through a product line, said product empty process alarm comprising:
a low pressure sensor, said low pressure sensor further comprising a diaphragm for measuring displacement, a diaphragm housing, said diaphragm inside of said diaphragm housing;
said diaphragm housing connected to and in communication with said product line wherein when pressure from said product in said product line is sufficiently high, said diaphragm stays in a home position and when said product runs low or out so as to cause a lowered pressure or vacuum, said diaphragm moves to an activated position;
wherein when said diaphragm moves to an activated position a wireless signal is generated;
a transmitter in communication with said low product sensor to accept said signal, said signal causing said transmitter to send a transmitted signal; and
a receiver capable of receiving said transmitted signal, and said receiver generating a discernible cue upon receiving said transmitted signal.

23. The apparatus of claim 22, further comprising:
a spool valve in communication with said low pressure sensor, wherein changing pressure detected by said low pressure sensor causes integral changes in said spool's position causing generation of said signal; and
wherein said signal is graduated allowing determination of amount of said product remaining in said product source.
